(19) United States
(12) Patent Application Publication
(10) Pub. No.: US 2020/0109043 A1
(43) Pub. Date: Apr. 9, 2020

(54) ENVIRONMENTALLY-CONTROLLED MOBILE DISTRIBUTION STATION

(71) Applicant: Fuel Automation Station, LLC, Bimingham, MI (US)

(72) Inventor: Ricky Dean Shock, Victoria, TX (US)

(21) Appl. No.: 16/151,610

(22) Filed: Oct. 4, 2018

(51) Int. Cl. B67D 7/84; B67D 7/40; B67D 7/58; B67D 7/78

(52) U.S. Cl. CPC B67D 7/845; B67D 7/40; B67D 2007/0426; B67D 7/78; B67D 7/58

(57) ABSTRACT

A distribution station includes a mobile trailer that has outer walls that enclose at least one interior compartment and the outer walls contain at least an exterior shell and thermal insulation adjacent the exterior shell. There is a pump, at least one manifold fluidly connected with the pump, a plurality of reels, a plurality of hoses connected with different ones of the reels, and a plurality of valves on the mobile trailer. Each valve is situated between the manifold and a respective different one of the reels. A plurality of fluid level sensors are associated with different ones of the hoses. A controller is configured to individually open and close the valves responsive to the fluid level sensors.

### BACKGROUND

Hydraulic fracturing (also known as fracking) is a well-stimulation process that utilizes pressurized liquids to fracture rock formations. Pumps and other equipment used for hydraulic fracturing typically operate at the surface of the well site. The equipment may operate until refueling is needed, at which time the equipment may be shut-down for refueling. Shut-downs are costly and reduce efficiency. More preferably, to avoid shut-downs fuel is replenished in a hot-refueling operation while the equipment continues to run. This permits fracking operations to proceed continuously. However, hot-refueling can be difficult to reliably sustain for the duration of the fracking operation.

### SUMMARY

A distribution station according to an example of the present disclosure includes a mobile trailer that has outer walls that enclose at least one interior compartment and the outer walls contain at least an exterior shell and thermal insulation adjacent the exterior shell. There is a pump, at least one manifold fluidly connected with the pump, a plurality of reels, a plurality of hoses connected with different ones of the reels, and a plurality of valves on the mobile trailer. Each valve is situated between the manifold and a respective different one of the reels. A plurality of fluid level sensors are associated with different ones of the hoses. A controller is configured to individually open and close the valves responsive to the fluid level sensors.

### BRIEF DESCRIPTION OF THE DRAWINGS

The various features and advantages of the present disclosure will become apparent to those skilled in the art from the following detailed description. The drawings that accompany the detailed description can be briefly described as follows.

FIGS. 1A and 1B illustrate an example mobile distribution station.

FIG. 2 illustrates an internal layout of a mobile distribution station.

FIG. 3 illustrates a sectioned view of a mobile distribution station.

FIG. 4 illustrates an isolated view of hose reels on a support rack used in a mobile distribution station.

FIG. 5 illustrates an example of a connection between a manifold, a control valve, and a reel.

FIG. 6 illustrates a representative portion of an outer wall of a mobile distribution station.

FIG. 7 illustrates a representative portion of an insulated cargo hold of a mobile distribution station.

FIG. 8 illustrates a representative portion of a window for deployment of hoses of a mobile distribution station.

### DETAILED DESCRIPTION

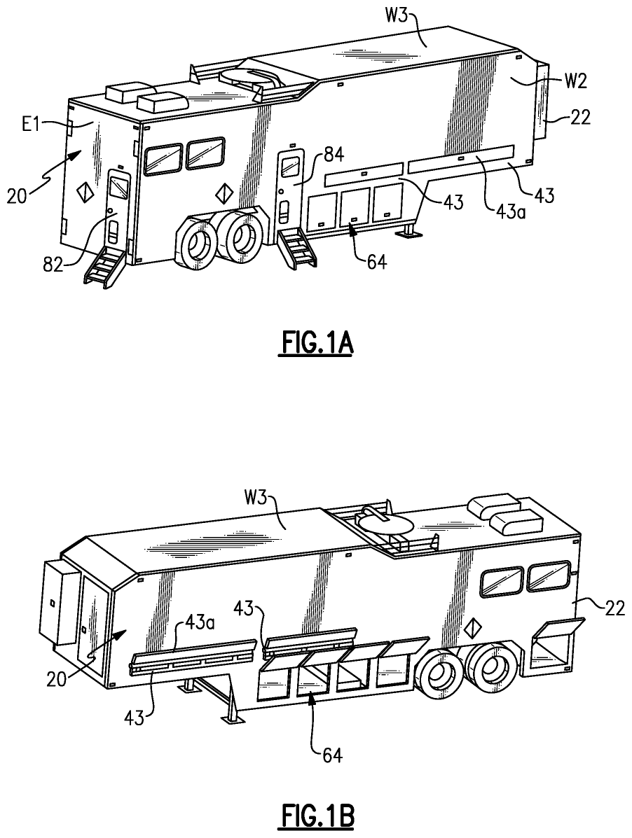

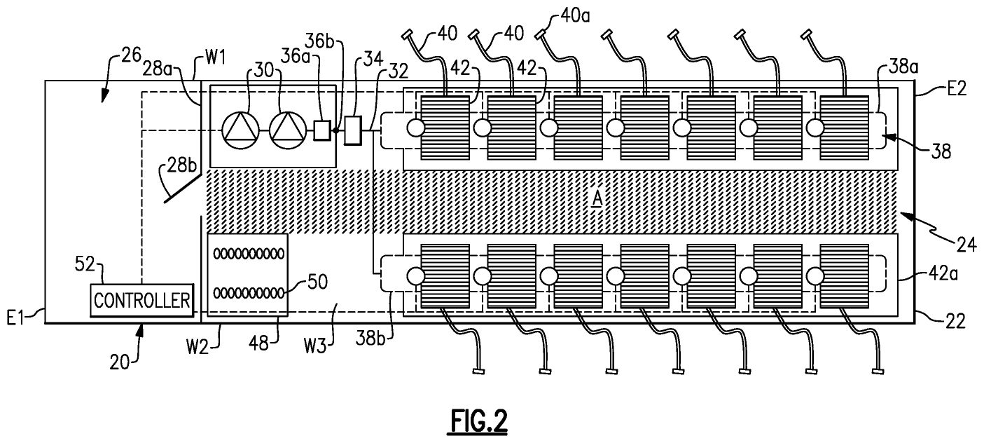

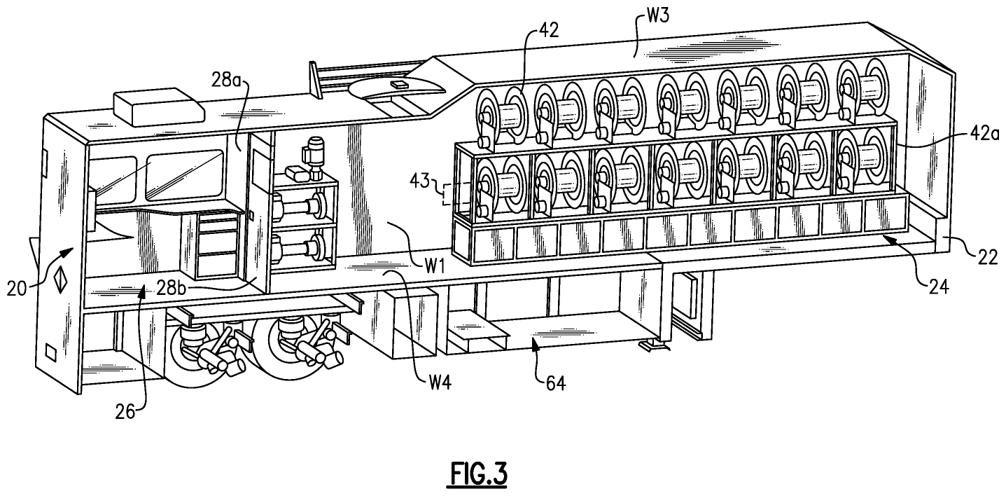

FIGS. 1A and 1B illustrate different perspective views of a mobile distribution station 20, while FIG. 2 illustrates an internal layout of the station 20 and FIG. 3 illustrates a sectioned view or selected portions of the station 20. As will be described, the station 20 may serve in a “hot-refueling” capacity to distribute fuel to multiple pieces of equipment while the equipment is running, such as fracking equipment at a well site. As will be appreciated, the station 20 is not limited to applications for fracking or for delivering fuel. The examples herein may be presented with respect to fuel delivery, but the station 20 may be used in mobile delivery of other fluids, in other gas/petroleum recovery operations, or in other operations where mobile refueling or fluid delivery will be of benefit.

In this example, the station 20 includes a mobile trailer 22. Generally, the mobile trailer 22 is elongated and has first and second opposed trailer side walls W1 and W2 that join first and second opposed trailer end walls E1 and E2. Most typically, the trailer 22 will also have a closed top or ceiling wall W3 and a floor wall. The walls W1, W2, W3, W4, E1, and E2 are outer or exterior walls. The mobile trailer 22 may have wheels that permit the mobile trailer 22 to be moved by a vehicle from site to site to service different hot-refueling operations. In this example, the mobile trailer 22 has two compartments. A first compartment 24 includes the physical components for distributing fuel, such as diesel fuel, and a second compartment 26 serves as an isolated control room for managing and monitoring fuel distribution. The compartments 24/26 are separated by an inside wall 28a that has an inside door 28b.

The first compartment 24 includes one or more pumps 30. Fuel may be provided to the one or more pumps 30 from an external fuel source, such as a tanker truck on the site. On the trailer 22, the one or more pumps 30 are fluidly connected via a fuel line 32 with one or more high precision registers 34 for metering fuel. The fuel line 32 may include, but is not limited to, hard piping. In this example, the fuel line 32 includes a filtration and air eliminator system 36a and one or more sensors 36b. Although optional, the system 36a is beneficial in many implementations, to remove foreign particles and air from the fuel prior to delivery to the equipment. The one or more sensors 36b may include a temperature sensor, a pressure sensor, or a combination thereof, which assist in fuel distribution management.

The fuel line 32 is connected with one or more manifolds 38. In the illustrated example, the station 20 includes two manifolds 38, represented at 38a and 38b, that are arranged on opposed sides of the compartment 24. As an example, the manifolds 38 are elongated tubes that are generally larger in diameter than the fuel line 32 and that have at least one inlet and multiple outlets. Each hose 40 is wound, at least initially, on a reel 42 that is rotatable to extend or retract the hose 40 externally through one or more windows 43 of the trailer 22. Each reel 42 may have an associated motor to mechanically extend and retract the hose 40.

As shown in an isolated view in FIG. 4, the reels 42 are mounted on a support rack 42a. In this example, the support rack 42a is configured with upper and lower rows of reels 42. There are two support racks 42a (FIG. 2) arranged on opposed sides of the first compartment 24, with an aisle (A) that runs between the support racks 42a. As will be appreciated, fewer or additional reels and hoses may be used than shown in the illustrated examples.

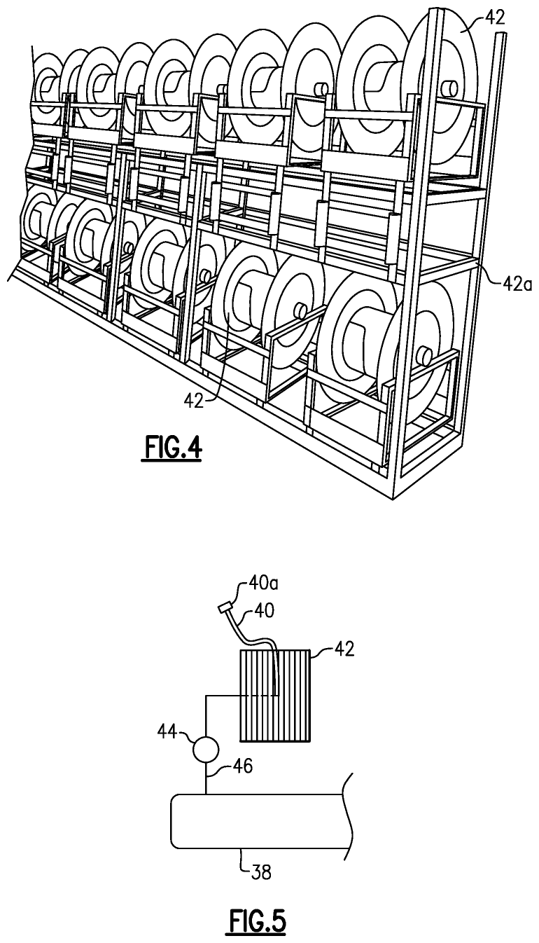

As shown in a representative example in FIG. 5, each hose 40 is connected to a respective one of the reels 42 and a respective one of a plurality of control valves 44. For example, a secondary fuel line 46 leads from the manifold 38 to the reel 42. The control valve 44 is in the secondary fuel line 46. The control valve 44 is moveable between open and closed positions to selectively permit fuel flow from the manifold 38 to the reel 42 and the hose 40. For example, the control valve 44 is an automated powered valve, such as a solenoid valve or pneumatic valve.

In the illustrated example, the first compartment 24 also includes a sensor support rack 48. The sensor support rack 48 holds integrated fuel cap sensors 50 (when not in use), or at least portions thereof. When in use, each integrated fuel cap sensor 50 is temporarily affixed to a piece of equipment (i.e., the fuel tank of the equipment) that is subject to the hot-refueling operation. Each hose 40 may include a connector end 40a and each integrated fuel cap sensor 50 may have a corresponding mating connector to facilitate rapid connection and disconnection of the hose 40 with the integrated fuel cap sensor 50. For example, the connector end 40a and mating connector on the integrated fuel cap sensor 50 form a hydraulic quick-connect.

At least the control valves 44, pump or pumps 30, sensor or sensors 36b, and register 34 are in communication with a controller 52 located in the second compartment 26. As an example, the controller 52 includes software, hardware, or both that is configured to carry out any of the functions described herein. In one further example, the controller 52 includes a programmable logic controller with a touch-screen for user input and display of status data. For example, the screen may simultaneously show multiple fluid levels of the equipment that is being serviced.

When in operation, the integrated fuel cap sensors 50 are mounted on respective fuel tanks of the pieces of equipment that are subject to the hot-refueling operation. The hoses 40 are connected to the respective integrated fuel cap sensors 50. Each integrated fuel cap sensor 50 generates signals that are indicative of the fuel level in the fuel tank of the piece of equipment on which the integrated fuel cap sensor 50 is mounted. The signals are communicated to the controller 52.

The controller 52 interprets the signals and determines the fuel level for each fuel tank of each piece of equipment. In response to a fuel level that falls below a lower threshold, the controller 52 opens the control valve 44 associated with the hose 40 to that fuel tank and activates the pump or pumps 30 if not already active. The pump or pumps 30 provide fuel flow into the manifolds 38 and through the open control valve 44 and reel 42 such that fuel is provided through the respective hose 40 and integrated fuel cap sensor 50 into the fuel tank. The lower threshold may correspond to an empty fuel level of the fuel tank, but more typically the lower threshold will be a level above the empty level to reduce the potential that the equipment completely runs out of fuel and shuts down. Since the other control valves 44 remain closed, no fuel flow to the hoses 40 connected to those valves 44. That is, fuel flows only to hoses 40 which have open valves 44.

The controller 52 also determines when the fuel level in the fuel tank reaches an upper threshold. The upper threshold may correspond to a full fuel level of the fuel tank, but more typically the upper threshold will be a level below the full level to reduce the potential for overflow. In response to reaching the upper threshold, the controller 52 closes the respective control valve 44 and ceases the pump or pumps 30. If other control valves 44 are open or are to be opened, the pump or pumps 30 may remain on. The controller 52 can also be programmed with an electronic stop failsafe measure to prevent over-filling. As an example, once an upper threshold is reached on a first tank and the control valve 44 is closed, but the pump 30 is otherwise to remain on to fill other tanks, if the fuel level continues to rise in the first tank, the controller 52 shuts the pump 30 off.

Multiple control valves 44 may be open at one time, to provide fuel to multiple fuel tanks at one time. Alternatively, if there is demand for fuel from two or more fuel tanks, the controller 52 may sequentially open the control valves 44 such that the tanks are refueled sequentially. For instance, upon completion of refueling of one fuel tank, the controller 52 closes the control valve 44 of the hose 40 associated with that tank and then opens the next control valve 44 to begin refueling the next fuel tank. Sequential refueling may facilitate maintaining internal pressure in the manifold and fuel line 32 above a desired or preset pressure threshold to more rapidly deliver fuel. Similarly, the controller 52 may limit the number of control valves 44 that are open at any one instance in order to maintain the internal pressure in the manifold and fuel line 32 above a desired or preset threshold. The controller 52 may perform the functions above while in an automated operating mode. Additionally, the controller 52 may have a manual mode in which a user can control at least some functions through the PLC, such as starting and stopped the pump 30 and opening and closing control valves 44. For example, manual mode may be used at the beginning of a job when initially filling tanks to levels at which the fuel cap sensors 50 can detect fuel and/or during a job if a fuel cap sensor 50 becomes inoperable. Of course, operating in manual mode may deactivate some automated functions, such as filling at the low threshold or stopping at the high threshold.

In addition to the use of the sensor signals to determine fuel level, or even as an alternative to use of the sensor signals, the refueling may be time-based. For instance, the fuel consumption of a given piece of equipment may be known such that the fuel tank reaches the lower threshold at known time intervals. The controller 52 is operable to refuel the fuel tank at the time intervals rather than on the basis of the sensor signals, although sensor signals may also be used to verify fuel level.

The controller 52 also tracks the amount of fuel provided to the fuel tanks. For instance, the register 34 precisely measures the amount of fuel provided from the pump or pumps 30. As an example, the register 34 is an electronic register and has a resolution of about 0.1 gallons. The register 34 communicates measurement data to the controller 52. The controller 52 can thus determine the total amount of fuel used to very precise levels. The controller 52 may also be configured to provide outputs of the total amount of fuel consumed. For instance, a user may program the controller 52 to provide outputs at desired intervals, such as by worker shifts or daily, weekly, or monthly periods. The outputs may also be used to generate invoices for the amount of fuel used. As an example, the controller 52 may provide a daily output of fuel use and trigger the generation of an invoice that corresponds to the daily fuel use, thereby enabling almost instantaneous invoicing.

The integrated fuel cap sensors 50 may each be hard-wired to the controller 52. The term “hard-wired” or variations thereof refers to a wired connection between two components that serves for electronic communication there between, which here is a sensor and a controller. Alternatively, the sensors 50 may communicate wirelessly with the controller 52.

The station 20 is adapted for operation in extreme environmental conditions. For example, the station 20 may be used in geographic regions that experience very high or low temperatures. In this regard, the station 20 is insulated to maintain a desired temperature inside. As examples, the desired temperature may be based on the comfort of operators inside the station, i.e., to provide a temperate working environment, and/or based on the operational temperatures of the components inside the station 20, i.e., to prevent freezing/ceasing or over-heating of components.

FIG. 6 depicts a representative example portion of the outer walls of the station 20 (walls W1, W2, W3, W4, E1, and E2). The outer walls are of multi-layer construction and contain an exterior shell 60 as a first or outermost layer and thermal insulation 62 as a second or inner layer adjacent the exterior shell 60. For example, the exterior shell 60 may be furred out and the thermal insulation 62 may be provided as furred strips that are received into the furred exterior shell 60. The first and second layers may be adhered together, to enhance durability. The exterior shell 60 faces outwards and thus has an exterior surface 60a that is directly exposed to the environment around the station 20. The thermal insulation 62 is on the inside of the exterior shell 60 and thus has no direct external environmental exposure. Generally, the exterior shell 60 serves as a protective layer, while the thermal insulation 62 serves for temperature control inside the station 20. In that regard, as described in further detail below, the thermal insulation 62 has a thermal resistance that is multiple times greater than the thermal resistance of the exterior shell 60.

In further examples, R-values, which are known in the thermal insulation field, can be used as an indicator of thermal resistance. For example, the exterior shell 60 has a shell R-value (R1) of thermal resistance per inch of thickness and the thermal insulation 62 has an insulation R-value (R2) of thermal resistance per inch of thickness, and R2 is greater than R1. In a further example, R2 is greater than R1 by a factor of at least 3. In an additional example, R2 is greater than R1 by a factor of 3 to 10 or 10 to 30. In the examples above, the units are assumed to be equal, such as R-value per inch (ft²-° F.-hr/BTU-in). R-values may also be given in larger increments, such as for two or three inch thicknesses. It is to be appreciated that equivalents units should be used for comparison and the ratios above. Additionally, it is to be understood that R-values are determined by a known standard and that, to the extent that there are multiple or varying standards, the same standard or the same standard with reasonable modifications are to be used for purpose of comparison and determination of the factor.

The exterior shell 60 and thermal insulation 62 may be formed of various materials to serve the functions thereof. For example, the exterior shell 60 is formed of a metallic material that is generally strong and tough. For instance, the exterior shell 60 is an aluminum or steel panel that has a thickness of 5 millimeters or less. The thermal insulation 62 may be formed of an insulating material, such as a fibrous material (e.g., fiberglass insulation) or a foam material (e.g., a closed or open pore foam panel). In further examples, the thermal insulation 62 may also have a composition that is flame resistant or fire retardant. The amount, thickness, and type of the thermal insulation 62 may be varied to control the insulating effect with respect to the components inside of the station 20 and/or the fuel or other fluid being delivered through the station 20. In one example, the thermal insulation 62 includes fiberglass insulation of 2 to 5 inch thickness.

In general, each of the walls W1, W2, W3, W4, E1, and E2 are of the above-described multi-layer construction. For instance, the walls W1, W2, W3, W4, E1, and E2 are formed entirely or substantially entirely of the multi-layer construction. Alternatively, at least the side walls W1, W2, E1, and E2 are formed entirely or substantially entirely of the multi-layer construction. The ceiling and/or floor walls W3 and W4 may not be formed entirely or substantially entirely of the multi-layer construction, or one or both of the walls W3 and W4 may entirely exclude the multi-layer construction.

As shown in FIGS. 1A, 1B, and 3, the station 20 further includes a cargo hold 64 below the interior compartments 24/26. In this example, there are one or more compartment sections forward of the wheels and axles of the station 20 and one or more compartment sections aft of the wheels and axles. For instance, the forward compartment section is in the middle one-third of the length of the station 20, while the aft section is in the rear one-third of the length of the station.

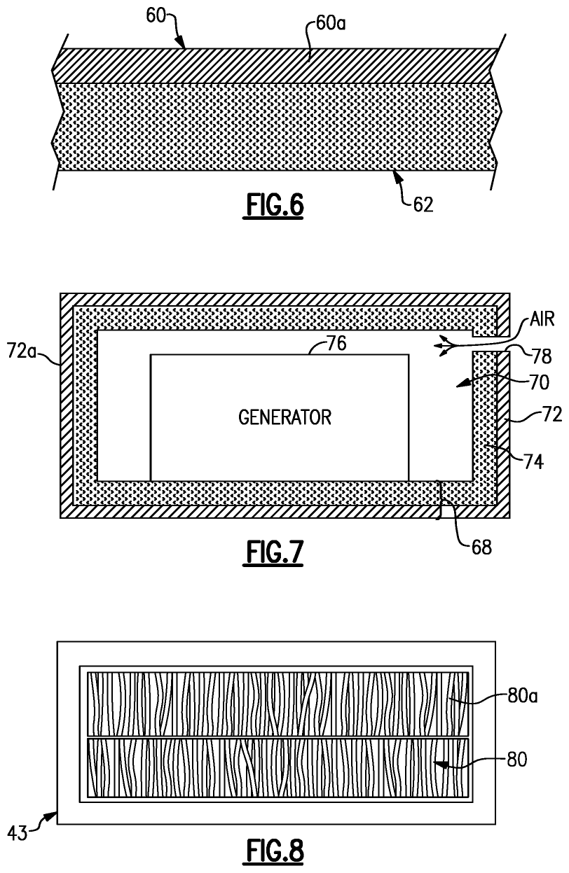

FIG. 7 depicts a representative example of one of the sections of the cargo hold 64. The cargo hold 64 includes cargo hold outer walls 68 that define an interior cargo compartment 70. The cargo hold outer walls 68 contain at least a cargo hold exterior shell 72 and cargo hold thermal insulation 74 adjacent the cargo hold exterior shell 72. The exterior shell 72 faces outwards and thus has an exterior surface 72a that is directly exposed to the environment around the station 20. The thermal insulation 74 is on the inside of the exterior shell 72 and thus has no direct external environmental exposure. Generally, the exterior shell 72 serves as a protective layer, while the thermal insulation 74 serves for temperature control inside the compartment 70.

As an example, the cargo hold exterior shell 72 is selected from the same materials as the exterior shell 60 described above, and the cargo hold thermal insulation 74 is selected from the same in materials as the thermal insulation 62 described above, including the example R-values and factors. As will be appreciated, however, the materials of the cargo hold exterior shell 72 and the exterior shell 60 may be the same or different, and the materials of the cargo hold thermal insulation 74 and the thermal insulation 62 may be the same or different. Likewise, the R-values and factors between the exterior shell 60 and the thermal insulation 62 may be the same or different as the R-values and factors between the exterior shell 72 and the thermal insulation 74. For instance, in order to shield contents of the cargo hold 64 from the environment a greater insulating effect may be desired for the compartment 70 of the cargo hold 64 than for the interior compartments 24/26. In that regard, the R-value factor between the exterior shell 72 and the thermal insulation 74 may be greater than the R-value factor between the exterior shell 60 and the thermal insulation 62. In one example, the R-value factor between the exterior shell 72 and the thermal insulation 74 may be greater than 5, such as from 5 to 10 or 10 to 30, while the R-value factor between the exterior shell 60 and the thermal insulation 62 may be 3 to 5. If less environmental shielding is needed for the cargo hold 64, the relationship may be inverse, such that the R-value factor between the exterior shell 72 and the thermal insulation 74 may be 3 to 5, while the R-value factor between the exterior shell 60 and the thermal insulation 62 may be from 5 to 10 or 10 to 30.

In a further example, there is a generator 76 situated in the interior cargo compartment 70. The cargo hold thermal insulation 74 serves to maintain a desired temperature in the compartment 70 for proper operation of the generator 76, while the exterior shell 72 serves to protect the generator 76 from the surrounding environment. In this case, the cargo hold outer walls 68 define an orifice 78 that opens to the exterior side 72a of the cargo hold exterior shell 72 for the generator 76 to intake air. Optionally, the generator 76 may also be a cold climate generator that is adapted for low temperature operation.

As shown in FIGS. 1A, 1B, and 3 the outer walls of the station 20 include one or more windows 43. The windows 43 are adjacent the reels 42 such that the hoses 40 can be deployed out through the windows 43 to extend to the equipment that is to be filled. As shown, there are hinged flaps 43a that can be opened and closed to, respectively, open and close the windows 43.

FIG. 8 shows a representative portion of one of the windows 43. In this example, the window 43 includes a flexible seal 80. The seal 80 is flexible to the degree that it can be readily moved or flexed by the hoses 40. For example, the hoses 40 can readily flex the seal 80 when being deployed and retracted through the window 43 and when moving laterally from side-to-side in the window 43. The flex of the seal 80 thus does not hinder hose movement, yet provides an environmental barrier that can move and continue to provide sealing as the hoses 40 move.

In the illustrated example, the flexible seal 80 includes bristles 80a. For example, a gang or curtain of bristles 80a is arranged along the edge or edges of the window 43. A bristle is an elongated, typically constant cross-section, filament that is most typically made of an elastomer or plastic material. The bristles 80a may be provided in such a number as to completely or substantially completely obscure open sight lines through the window 43, thus providing good sealing against air infiltration into the station 20 or escape of air from the station 20. The bristles 80a also provide the additional benefit of facilitating cleaning of the hoses 40. For instance, as the hoses 40 are retracted into the station 20 they may pick up debris. The bristles 80a dislodge such debris by flexing around the hoses 40 and contacting and “brushing” the debris during hose retraction. Although bristles 80a provide sealing and cleaning, it is to be understood that the seal 80 may alternatively include a solid flexible flap or flaps that serve the similar purposes.

As shown in FIGS. 1A and 1B the station 20 further includes multiple options for operator access to the interior compartments 24/26 from the outside. For instance, the station 20 includes exterior doors 82 and 84. The exterior door 82 is located in the endwall E1 and the exterior door 84 is located in the sidewall W2. The exterior door 82 leads directly into the compartment 26, i.e., the control compartment that contains the controller 52, while the exterior door 84 leads directly into the compartment 24, i.e., the component compartment that contains the pumps 30, reels 42, etc. Such a multi-entry configuration facilitates operation of the station 20 by reducing the need for an operator to walk through the compartment 24 to access the compartment 26, and vice-versa. Thus, operators accessing the compartment 24 need not interfere with or crowd an operator in the compartment 26 and operators accessing the compartment 26 need not interfere with or crowd an operator in the compartment 24. As will be appreciated, the doors 82/84, along with any windows in the station 20, may also be insulated or contain sealing to further facilitate environmental control in the station 20.

The distribution station as recited in claim 1, wherein the mobile trailer is elongated and includes opposed elongated side and opposed endwall sides, and the mobile trailer includes an endwall door in one of the endwall sides and a side door in one of the elongated sides.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A distribution station comprising:
a mobile trailer having outer walls that enclose at least one interior compartment, the outer walls containing at least an exterior shell and thermal insulation adjacent the exterior shell;
a pump on the mobile trailer;
at least one manifold on the mobile trailer and fluidly connected with the pump;
a plurality of reels on the mobile trailer;
a plurality of hoses, each said hose connected with a different one of the reels;
a plurality of valves on the mobile trailer, each said valve situated between the at least one manifold and a respective different one of the reels;
a plurality of fluid level sensors, each said fluid level sensor being associated with a different one of the hoses; and
a controller configured to individually open and close the valves responsive to the fluid level sensors.

2. The distribution station as recited in claim 1, wherein the exterior shell is metallic.

3. The distribution station as recited in claim 1, wherein the exterior shell has a shell R-value of thermal resistance per inch of thickness and the thermal insulation has an insulation R-value of thermal resistance per inch of thickness, and the insulation R-value is greater than the shell R-value by a factor of at least 3.

4. The distribution station as recited in claim 3, wherein the insulation R-value is greater than the shell R-value by a factor of 3 to 10.

5. The distribution station as recited in claim 1, wherein the thermal insulation is fibrous.

6. The distribution station as recited in claim 1, wherein the exterior shell is metallic, the thermal insulation is fibrous, the exterior shell has a shell R-value of thermal resistance per inch of thickness, the thermal insulation has an insulation R-value of thermal resistance per inch of thickness, and the insulation R-value is greater than the shell R-value by a factor of 3 to 10.

7. The distribution station as recited in claim 1, wherein the mobile trailer further comprises a cargo hold below the interior compartment, the cargo hold includes cargo hold outer walls that define an interior cargo compartment, the cargo hold outer walls contain at least a cargo hold exterior shell and cargo hold thermal insulation adjacent the cargo hold exterior shell, and a generator situated in the interior cargo compartment.

8. The distribution station as recited in claim 7, wherein the cargo hold outer walls define an orifice that opens to an exterior side of the cargo hold exterior shell for the generator to intake air.

9. The distribution station as recited in claim 1, wherein the outer walls include one or more windows adjacent the reels and through which the hoses can extend, the one or more windows including a flexible seal.

10. The distribution station as recited in claim 9, wherein the flexible seal includes bristles.

11. The distribution station as recited in claim 1, wherein the mobile trailer is elongated and includes opposed elongated side and opposed endwall sides, and the mobile trailer includes an endwall door in one of the endwall sides and a side door in one of the elongated sides.

12. The distribution station as recited in claim 1, wherein the outer walls include one or more windows adjacent the reels and through which the hoses can extend, the one or more windows including a flexible seal, the exterior shell is metallic, the thermal insulation is fibrous, the exterior shell has a shell R-value of thermal resistance per inch of thickness, the thermal insulation has an insulation R-value of thermal resistance per inch of thickness, and the insulation R-value is greater than the shell R-value by a factor of 3 to 10.

13. The distribution station as recited in claim 12, wherein the mobile trailer further comprises a cargo hold below the interior compartment, the cargo hold includes cargo hold outer walls that define an interior cargo compartment, the cargo hold outer walls contain at least a cargo hold exterior shell and cargo hold thermal insulation adjacent the cargo hold exterior shell, and a generator situated in the interior cargo compartment.

14. The distribution station as recited in claim 13, wherein the cargo hold outer walls define an orifice that opens to an exterior side of the cargo hold exterior shell for the generator to intake air.

15. A distribution station comprising:
a mobile trailer including a pump, a manifold fluidly connected with the pump, a flow register located between the pump and the manifold, hoses fluidly connected with the manifold, valves situated between the manifold and the hoses, fluid level sensors connectable at ends of the hoses, and a controller configured to open and close the valves responsive to the fluid level sensors, the mobile trailer having outer walls that enclose at least one interior compartment in which the pump, the register, and the manifold are located, the outer walls containing at least an exterior shell and thermal insulation adjacent the exterior shell.

16. A distribution station comprising:
a mobile trailer including a pump, a manifold fluidly connected with the pump, a flow register located between the pump and the manifold, hoses fluidly connected with the manifold, valves situated between the manifold and the hoses, fluid level sensors connectable at ends of the hoses, and a controller configured to open and close the valves responsive to the fluid level sensors, the mobile trailer having multi-layer outer walls that enclose at least one interior compartment in which the pump, the register, and the manifold are located.

17. The distribution station as recited in claim 16, wherein the multi-layer outer walls include at least a first layer of an exterior shell and a second layer of thermal insulation adjacent the first layer.
